(19) United States
(12) Patent Application Publication
(10) Pub. No.: US 2021/0114793 A1
(43) Pub. Date: Apr. 22, 2021

(54) MICROWAVABLE FOOD CONTAINER

(71) Applicant: Packaging Concepts, Inc., St. Louis, MO (US)

(72) Inventor: Adam J. Irace, Ballwin, MO (US)

(73) Assignee: Packaging Concepts, Inc., St. Louis, MO (US)

(21) Appl. No.: 17/046,789

(22) PCT Filed: Apr. 11, 2019
(86) PCT No.: PCT/US2019/027102

§ 371 Date: Oct. 11, 2020

Related U.S. Application Data
(60) Provisional application No. 62/656,085, filed on Apr. 11, 2018.

(51) Int. Cl. B65D 81/34; B65D 65/46; B65D 65/42; B65B 1/02; B65B 1/04; B65B 25/22

(52) U.S. Cl. CPC B65D 81/3469; B65D 65/466; B65D 65/42; B65B 1/02; B65D 2581/3497; B65B 25/22; B65D 2581/3421; B65D 2581/3454; B65B 1/04

(57) ABSTRACT

Microwavable food containers (10) made at least in part from biodegradable and/or compostable materials and processes for producing these containers are described.

### FIELD OF THE INVENTION

The present invention generally relates to microwavable food containers made at least in part from biodegradable and/or compostable materials and processes for producing these containers.

### BACKGROUND OF THE INVENTION

Conventional microwavable food containers such as those used for microwave popcorn are typically constructed with a series of paper layers, adhesives, and a susceptor. The susceptor converts microwave energy into heat and thereby heats food contained in the container. Some of the materials used to construct these containers are not biodegradable, let alone compostable. For example, susceptors are typically formed by metallizing a polyester film, particularly a polyethylene terephthalate (PET) film. However, PET is not a biodegradable or compostable polymer. Also, some of the adhesives used to join paper layers and susceptor may not be biodegradable or compostable. There is an increasing demand for consumer products that are biodegradable and/or compostable to reduce the amount of waste materials that are diverted to landfills and persistent in the environment. Thus, there remains a need for microwavable food containers that are constructed of materials that are biodegradable and/or compostable.

### SUMMARY

Various aspects of the present invention relate to a container comprising:

a perimeter wall that defines an interior of the container, the interior of the container being configured to receive a microwavable food item therein; and

a susceptor supported on the perimeter wall of the container, the susceptor comprising a substrate and a coating supported on the substrate, wherein the substrate comprises a biodegradable polymer that has stable physical and/or chemical properties at temperatures of at least about 150° C.

Further aspects of the present invention relate to a container comprising:

a perimeter wall that defines an interior of the container, the interior of the container being configured to receive a microwavable food item therein; and

a susceptor supported on the perimeter wall of the container, the susceptor comprising a substrate, wherein the substrate comprises a biodegradable polymer comprising a cellulosic polymer and optionally a coating supported on the substrate, and wherein the susceptor has an optical density that is no greater than about 0.2, no greater than about 0.18, no greater than about 0.15, no greater than about 0.12, no greater than about 0.1, or no greater than about 0.05.

Other aspects of the present invention relate to various processes for producing a microwavable container. Some processes comprise:

bonding a first layer of a first material and a susceptor with a first adhesive, wherein the susceptor comprises a substrate and optionally a coating supported on the substrate and wherein the substrate comprises a biodegradable polymer;

bonding a second layer of a second material and the first layer with a second adhesive to form a laminate material wherein the susceptor is positioned between the first layer and the second layer; and

applying a third adhesive to one or more of a first end margin, a second end margin, and/or a longitudinal edge margin of the laminate material.

### BRIEF DESCRIPTION OF THE DRAWINGS

FIG. 1 is a fragmentary top plan view of a microwavable food container.

FIG. 2 is a cross-section taken in the plane of line 2-2- of FIG. 1.

FIG. 3 is an enlarged schematic illustration of a portion of FIG. 2.

FIG. 4 is an enlarged schematic illustration of another portion of FIG. 2.

Corresponding reference characters indicate corresponding parts throughout the drawings.

### DETAILED DESCRIPTION

The present invention generally relates to various microwavable containers, particularly microwavable food containers such as microwave popcorn bags and processes of making these containers. In particular, the present invention includes microwavable containers constructed of one or more biodegradable and/or compostable materials. The term “biodegradable” generally refers to the ability of a material to be broken down by biological processes (e.g., physically and/or chemically by microorganisms) within a reasonable amount of time (e.g., within about 1 or about 2 years). The term “compostable” generally refers to the ability of a material to be broken down by biological processes without leaving toxic residues and within a reasonable amount of time that is typically shorter as compared to a biodegradable material (e.g., within about 6 months or 1 year).

Various microwavable food containers of the present invention comprise a perimeter wall that defines an interior of the container, the interior of the container being configured to receive a microwavable food item therein; and a susceptor supported on the perimeter wall of the container. In various embodiments, the susceptor comprises a polymer that is biodegradable and/or compostable. In some embodiments, the perimeter wall of the container and the susceptor are constructed from materials that are biodegradable and/or compostable. For example, the perimeter wall of the container can be constructed of non-fluorinated paper that is biodegradable and compostable. Typically, the container also includes one or more adhesives. In certain embodiments, the container comprises adhesives that are biodegradable and/or compostable. In further embodiments, the container consists essentially of materials that are biodegradable and/or compostable. In still other embodiments, the container consists entirely of materials that are biodegradable and/or compostable.

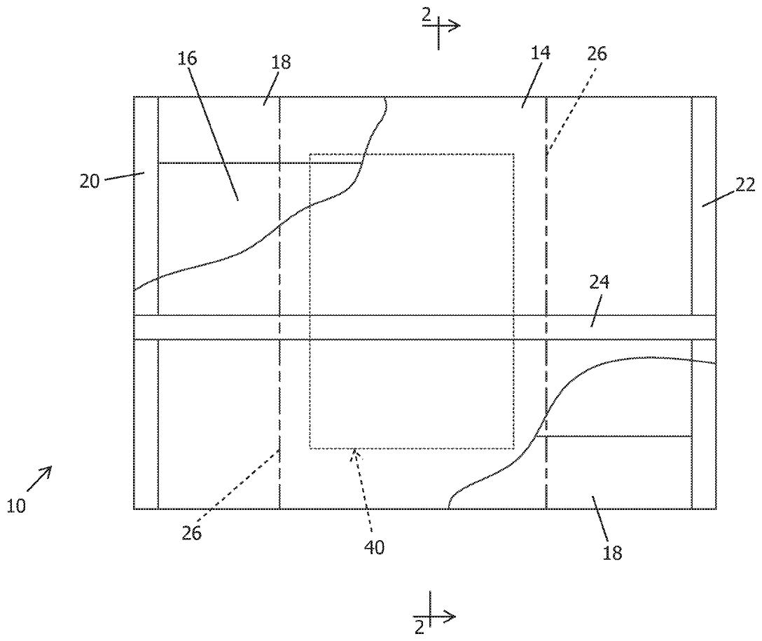

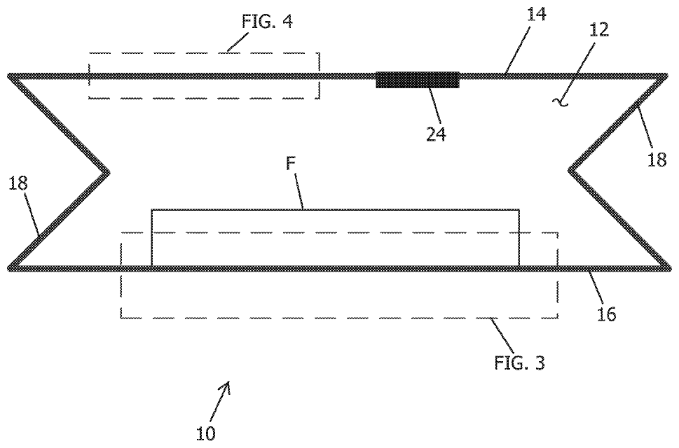

Referring to FIGS. 1 and 2, one embodiment of a microwavable food container is generally indicated at reference number 10. In this embodiment, the container is a bag (e.g., for microwave popcorn). Further embodiments of the present invention include other containers such as bowls, tubs, cartons, and boxes. As shown in FIGS. 1 and 2, the container 10 has a perimeter wall that extends around an interior 12 of the container. The interior 12 of the container 10 is configured to receive a microwavable food item F therein. In one or more embodiments, the food item F can comprise popcorn kernels, for example, popcorn kernels and other food items such as oil, flavorings, salt, sugar, etc. It will be appreciated, however, that the container can be used to contain and hold other food items in other embodiments.

In the illustrated embodiment, the container 10 comprises a gusseted pinched-end container. Thus, the perimeter wall of the container comprises a top panel 14, a bottom panel 16, and first and second gusseted side panels 18. Each of the panels 14, 16, 18 extends along a length of the container from a first end margin to a second end margin. The panels are 14, 16, 18 are sealed together along the first and second end margins at first and second end seals 20, 22, respectively. Each end seal 20, 22 extends along the full width of the container 10. In one or more embodiments, one or more of the panels 14, 16, 18 are sealed together at the end seals 20, 22 by an adhesive such as a heat seal adhesive. For example, adhesives include water-soluble polyvinyl acetate adhesives. In various embodiments, a heat seal adhesive that is biodegradable and/or compostable is used to form the end seals 20, 22. In other embodiments, the end seals can be formed in other ways without departing from the scope of the invention.

The illustrated container further includes a longitudinal seal 24 at which longitudinal edge margins of a sheet of material forming the container are sealed together as will be explained in further detail below. In one or more embodiments, the longitudinal edge margins are sealed together at the longitudinal seal 24 by an adhesive. For example, adhesives include water-soluble polyvinyl acetate adhesives. In various embodiments, an adhesive that is biodegradable and/or compostable is used to form longitudinal seal 24. In other embodiments, one or more longitudinal seals can be formed in other ways without departing from the scope of the invention.

In general, the susceptor 40 is configured to absorb microwaves and generate heat during microwave cooking. The susceptor 40 can be shaped and arranged to be positioned below the food item F in the interior of the container 10 such that the food is located generally above the susceptor when the container is supported on the bottom panel 16. For example, the susceptor 40 can have a perimeter edge margin that has about the same size and shape as a perimeter of the food item F or a larger or smaller size than the food. The food item F can be aligned above the susceptor 40 such that substantially the entirety of the bottom of the food is supported on and located above the susceptor when the container 10 is supported on the bottom panel 16.

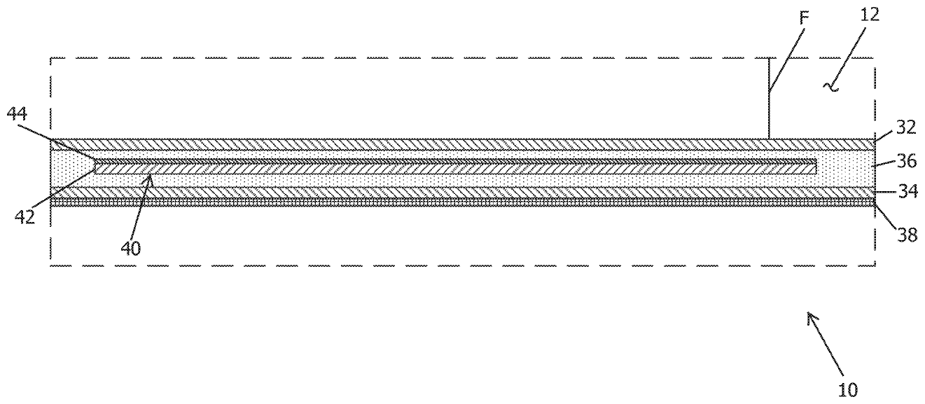

In the illustrated embodiment, the container 10 comprises susceptor 40 supported on the interior of the perimeter wall (e.g., supported on the interior of panel 16). The susceptor comprises a substrate 42 (shown on FIG. 3) and a coating 44 (which is optional according to some embodiments of the present invention) supported on the substrate (also shown on FIG. 3). In one or more embodiments, the substrate 42 comprises a polymer substrate (e.g., film). Typically, the substrate 42 comprises an ovenable or heat-resistant polymer substrate that has stable physical and/or chemical properties at temperatures of at least about 150° C., at least about 175° C., at least about 200° C., etc. In various embodiments, the substrate comprises a biodegradable and/or compostable polymer. For example, various cellulosic polymers, such as cellophane, are biodegradable and/or compostable. In some embodiments, the polymer substrate is a heat-resistant cellophane. Other biodegradable and/or compostable polymers can be used for the polymer substrate including polylactic acid (PLA), polyglycolic acid (PGA), poly(lactic-co-glycolic acid) (PLGA), polyhydroxyalkanoate (PHA), other natural polyesters, combinations of these polymers, and various blends containing these polymers.

A coating 44 can be supported on the substrate 42. The coating can comprise a variety of metal-containing materials and/or ceramic materials. Metal-containing materials can include one or more metals such as titanium, aluminum, copper, nickel, zinc, gold, silver, tin, iron, and combinations thereof. In some embodiments, the metal-containing material comprises a metal oxide such as titania, alumina, and combinations thereof. In further embodiments, the coating supported on the substrate comprises a ceramic material such as silica. The metal-containing and/or ceramic materials forming the coating 44 can be deposited on substrate 42 by various deposition techniques including vacuum metallization. The degree of deposition/metallization on substrate 42 can be determined by measuring the optical density of the susceptor (i.e., the substrate after coating deposition). In various embodiments, the susceptor has an optical density of from about 0.1 to about 0.5, from about 0.1 to about 0.4, from about 0.1 to about 0.3, from about 0.1 to about 0.2, from about 0.15 to about 0.5, from about 0.15 to about 0.4, from about 0.15 to about 0.35, from about 0.15 to about 0.3, from about 0.2 to about 0.5, from about 0.2 to about 0.4, from about 0.2 to about 0.3, from about 0.3 to about 0.5, from about 0.3 to about 0.4, or from about 0.4 to about 0.5. Optical density can be measured with a densitometer such as a Tobias transmission densitometer (e.g., Model TBX-MC). Transmissive density equals log₁₀ (1/Transmittance) where transmittance is the amount of light that passes from a controlled source through the material being tested.

The coating supported on the substrate can be randomly distributed or can be patterned where exposed portions of the substrate are coated and where exposed portions are not coated. In some embodiments, the patterned coating on the substrate is a non-random pattern. In certain embodiments, the patterned coating on the substrate is a geometric pattern.

It has been surprisingly discovered that some substrates (e.g., cellulosic polymers such as cellophane) have been found to function as a susceptors with only very small amounts of a coating or no coating at all. For example, various embodiments of the present invention relate to a container comprising: a perimeter wall that defines an interior of the container, the interior of the container being configured to receive a microwavable food item therein; and a susceptor supported on the perimeter wall of the container, the susceptor comprising a substrate, wherein the substrate comprises a biodegradable polymer (e.g., comprising a cellulosic polymer) and optionally a coating supported on the substrate, and wherein the susceptor has an optical density that is no greater than about 0.2, no greater than about 0.18, no greater than about 0.15, no greater than about 0.12, no greater than about 0.1, or no greater than about 0.05. As noted, the coating can comprise a variety of metal-containing materials and/or ceramic materials. Metal-containing materials can include one or more metals such as titanium, aluminum, copper, nickel, zinc, gold, silver, tin, iron, and combinations thereof. In some embodiments, the metal-containing material comprises a metal oxide such as titania, alumina, and combinations thereof. In further embodiments, the coating supported on the substrate comprises a ceramic material such as silica.

Various containers of the present invention comprise a substrate that is free or essentially free of a coating and/or metal. For example, the substrate can be free or essentially free of metals selected from the group consisting of titanium, aluminum, copper, nickel, zinc, gold, silver, tin, iron, and combinations thereof. In certain embodiments, the substrate is free or essentially free of metal oxides selected from the group consisting of titania, alumina, and combinations thereof. In further embodiments, the substrate is free or essentially free of a ceramic material. As used herein, the phrase “essentially free” of a component refers to amounts of that component that would be considered unavoidable impurities. For example, the amount of the component on the substrate can be less than would result in an optical density of 0.05, 0.01, or even lower.

Further, in various embodiments, the susceptor consists or consists essentially of the biodegradable polymer. For example, the susceptor can consists or consists essentially of the cellulosic polymer. In certain embodiments, the susceptor consists or consists essentially of cellophane. The susceptor consists or consists essentially of a polymer selected from the group consisting of polylactic acid (PLA), polyglycolic acid (PGA), poly(lactic-co-glycolic acid) (PLGA), polyhydroxyalkanoate (PHA), other natural polyesters, combinations of these polymers, and various blends containing these polymers. As used herein, the phrase “consists essentially” of a component indicates, for example, that the specified component may contain minor amounts of other materials that do not affect the characteristics of the specified component or amounts that would be considered impurities. For example, the other materials may be present in concentrations that are, for example, less than 5 wt. %, less than 1 wt. %, less than 0.1 wt. %, less than 0.01 wt. %, or even less than 0.001 wt. %.

In various embodiments, the container is free or essentially free of metals e.g., metals selected from the group consisting of titanium, aluminum, copper, nickel, zinc, gold, silver, tin, iron, and combinations thereof (not including any metal associated with a food item received in the interior of the container). In some embodiments, the container is free or essentially free of metal oxides, e.g., metal oxides selected from the group consisting of titania, alumina, and combinations thereof (not including any metal oxides associated with a food item received in the interior of the container). In certain embodiments, the container is free or essentially free of ceramic materials (not including any ceramic materials associated with a food item received in the interior of the container).

The container 10 can be a component of a shelf-stable retail packaging system for the food item F. In the illustrated embodiment, the food item F can be placed in the middle section of the container 10 and end sections of the container can be flattened and folded over the middle section of the container along fold lines 26 to reduce the packaged size of the container. The folded container 10 (or an unfolded container in other embodiments) can be loaded into a sealed (e.g., fluid-impermeable) wrapper (not shown). The container can also be wrapped in a sealing wrapper, for example, to enhance the shelf stability of the food item contained therein. In one or more embodiments, the sealing wrapper can also be formed from a biodegradable and/or compostable material. In some embodiments, the sealing wrapper is a cellulosic material such as cellophane, glassine, or paper (e.g., a non-fluorinated paper). A plurality of wrapped containers can be packaged together in a box.

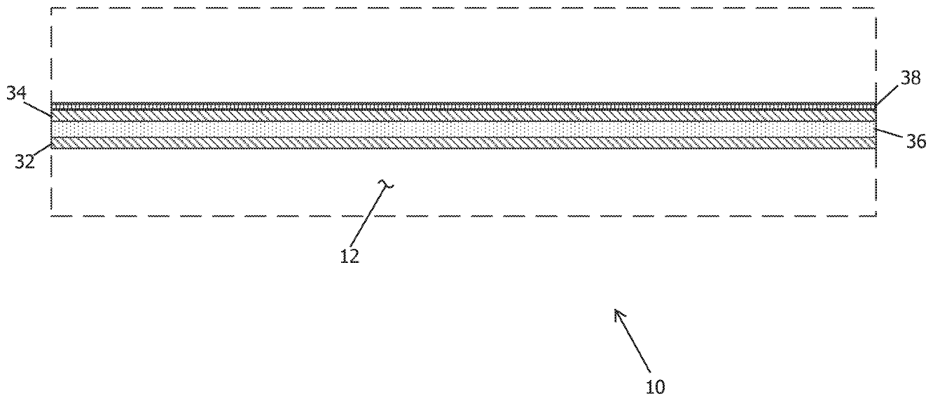

Referring to FIGS. 3 and 4, in one or more embodiments, the perimeter wall of the container 10 can be formed from one or more sheets of a multi-ply material. In the illustrated embodiment, the multi-ply material comprises an inner paper layer 32 and an outer paper layer 34 that is laminated to the inner paper layer by an adhesive layer 36. The inner paper layer 32 defines the interior 12 of the container 10. The outer paper layer 34 has an outer surface that is configured to have ink 38 printed thereupon. One or both paper layers 32, 34 can comprise bleached paper. In one or more embodiments, one or both of the paper layers 32, 34 comprise a grease-resistant paper. In certain embodiments, one or both of the inner paper layer 32 and the outer paper layer 34 can comprise a non-fluorinated paper. The paper used to form one or both of the paper layers 32, 34 can be biodegradable and/or compostable in certain embodiments.

The adhesive layer 36 suitably comprises a biodegradable and/or compostable adhesive such as an adhesive formed from a water-soluble emulsion. The adhesive layer can also have other configurations in other embodiments. Suitably, the ink 38 comprises a biodegradable and/or compostable ink. In one embodiment, the ink 38 comprises a water-based ink. Other inks can also be used in other embodiments.

Referring to FIG. 3, a susceptor, generally indicated at 40, is received between the inner and outer paper layers 32, 34 along the bottom panel 16 of the container 10. In other embodiments, the susceptor could be supported on the inner surface of the inner paper layer instead of being laminated between the paper layers. The susceptor can be positioned in the container in still other ways in other embodiments. In the illustrated embodiment, the susceptor 50 is fully embedded in the adhesive layer 32 such that adhesive extends about the perimeter and along top and bottom surfaces of the susceptor. In other embodiments, the susceptor could be arranged so that one or both of the top and bottom surfaces of the susceptor are in direct contact with the inner paper layer and/or the outer paper layer, respectively. The illustrated susceptor 40 can comprises a substrate 42 and a coating 44 as described herein.

The microwavable food containers of the present invention can be made by various processes. For example, in some embodiments, the process for producing a microwavable container (or precursor thereof) comprises bonding a first layer of a first material and a susceptor with a first adhesive, wherein the susceptor comprises a substrate and an optional coating supported on the substrate and wherein the substrate comprises a biodegradable polymer as specified herein; bonding a second layer of a second material and the first layer with a second adhesive to form a laminate material wherein the susceptor is positioned between the first layer and the second layer; and applying a third adhesive to one or more of a first end margin, a second end margin, and/or a longitudinal edge margin of the laminate material. In some embodiments, one or more of the first end margin, the second end margin, and/or the longitudinal edge margin are sealed before, during, or after the container is filled with a food item. In one or more embodiments, the process also includes forming the microwavable container (e.g., shaping or folding).

The susceptor comprises a substrate and a coating as described herein. The first adhesive, second adhesive, and third adhesive can each be biodegradable and/or compostable adhesives, also as described herein. Further, the first material and second can be non-fluorinated paper. Accordingly, in various embodiments, the container can consist essentially or consist entirely of materials that are biodegradable and/or compostable.

Referring back to FIGS. 1-4, once the laminate material is formed, a sheet of the laminate material can be formed into one or more containers 10. In an exemplary embodiment, a plurality of containers is formed in an inline process from a contiguous elongate sheet of the laminate material having a plurality of susceptors 40 at spaced apart locations along the length of the elongate sheet. Biodegradable and/or compostable adhesive can applied to one or both of the longitudinal edge margins of the elongate sheet. In addition, biodegradable and/or compostable adhesive can be applied to bands that extend along the width of the elongate sheet at spaced apart locations along the length of the elongate sheet between adjacent susceptors 40. The elongate sheet is folded along longitudinal fold lines to form the gusseted side panels 18 and to arrange the longitudinal edge margins in overlapping engagement. As the longitudinal edge margins of the elongate sheet are pressed together in overlapping engagement, the adhesive applied to the longitudinal edge margins seals the longitudinal edge margins together as they are brought into overlapping engagement to from the longitudinal seal 24. Along each of the heat seal adhesive bands, portions of the elongate sheet forming the top panels 14, the bottom panels 16, and the inwardly folded gusseted side panels 18 of the containers 10 can be pressed together and heated to form the end seals 20, 22 of the containers 10. Optionally, one or both of the end seals can be left unsealed until after the container is filled with food item F. The elongate sheet can be cut widthwise at spaced apart locations along its length to separate the individual containers 10. In certain embodiments, the containers 10 can be folded in a tri-fold configuration along the fold lines 26.

Processes of the present invention can further include the step of filling the containers with a microwavable food item, such as popcorn kernels. Each food item can positioned generally above the susceptor. Referring back to FIGS. 1-4, after filling with food item F, both end seals 20, 22 are sealed.

The containers can also be wrapped in a sealed wrapper as described herein and/or boxed for retail sale.

Other processes for forming the container can also be used without departing from the scope of the invention. In certain embodiments, the order of the processing steps differs from the order of the steps set forth above. For example, separate sheets of the laminate material that are each configured to form a single container may be cut or otherwise formed at any point in the process. It is understood that any of the other processing steps described above can be performed on an individual sheet used to form a single container.

### EXAMPLES

### Example 1

A series of microwave popcorn test bags were prepared susceptors with metallized cellophane. The bag material was non-fluorinated paper. However, fluorinated paper could be used as an alternative. The bags were filled with popcorn and microwaved to evaluate bag performance including pop volume and number of unpopped corn kernels (UPKs). The performance of the test bags was compared to the performance of bags constructed of fluorinated paper and non-fluorinated bags and having a conventional metallized PET susceptor (optical density=approximately 0.25). Tables 1-8 present the results of this evaluation.

TABLE 1
Formulation: Fat Free Butter-Control Bag
(Fluorinated Bag Material with Metallized PET Susceptor)
Bag: Full Size
Net Weight: 3.0 oz. (85.0 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:50 | 3600 | 73.1 | 17 | 3.0 | 70.1 |
| 2 | 1:55 | 3450 | 71.6 | 17 | 2.8 | 68.8 |
| 3 | 1:51 | 3450 | 71.1 | 12 | 2.0 | 69.1 |
| 4 | 1:55 | 3500 | 71.5 | 24 | 4.3 | 67.2 |
| 5 | 1:54 | 3550 | 72.1 | 9 | 1.5 | 70.6 |
| 6 | 1:52 | 3550 | 73.2 | 22 | 4.1 | 69.1 |
| 7 | 1:57 | 3450 | 70.8 | 12 | 2.1 | 68.7 |
| 8 | 1:57 | 3500 | 72.0 | 9 | 1.6 | 70.4 |
| 9 | 1:51 | 3500 | 71.4 | 22 | 3.8 | 67.6 |
| 10 | 1:56 | 3450 | 71.1 | 15 | 2.7 | 68.4 |
| | Average | 3500 | 71.79 | 15.90 | 2.79 | 69.00 |
| | Average | 14.17 | | | | |
| | Cups | | | | | |

TABLE 2
Formulation: Fat Free Butter-Control Susceptor
(Non-Fluorinated Bag Material with Metallized PET Susceptor)
Bag: Full Size
Net Weight: 3.0 oz. (85.0 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:52 | 3400 | 70.3 | 13 | 2.1 | 68.2 |
| 2 | 1:49 | 3450 | 71.2 | 19 | 3.4 | 67.8 |
| 3 | 1:54 | 3400 | 71.1 | 14 | 2.4 | 68.7 |
| 4 | 1:58 | 3500 | 73.0 | 17 | 2.5 | 70.5 |
| 5 | 1:51 | 3400 | 71.4 | 21 | 3.7 | 67.7 |
| 6 | 1:56 | 3350 | 70.3 | 13 | 2.1 | 68.2 |
| 7 | 1:54 | 3450 | 71.7 | 16 | 2.7 | 69.0 |
| 8 | 1:52 | 3400 | 70.2 | 20 | 3.2 | 67.0 |
| 9 | 1:51 | 3450 | 71.8 | 18 | 3.4 | 68.4 |
| 10 | 1:52 | 3450 | 72.4 | 22 | 3.7 | 68.7 |
| | Average | 3425 | 71.34 | 17.30 | 2.92 | 68.42 |
| | Average | 13.87 | | | | |
| | Cups | | | | | |

TABLE 3
Formulation: Fat Free Butter-Test Bag
(Non-Fluorinated Bag Material with Metallized
Cellophane Susceptor with Optical Density of 0.175)
Bag: Full Size
Net Weight: 3.0 oz. (85.0 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:49 | 3300 | 70.7 | 21 | 3.6 | 67.1 |
| 2 | 1:49 | 3450 | 71.3 | 23 | 3.7 | 67.6 |
| 3 | 1:53 | 3450 | 71.4 | 10 | 1.7 | 69.7 |
| 4 | 1:56 | 3450 | 69.8 | 14 | 2.4 | 67.4 |
| 5 | 1:49 | 3400 | 70.7 | 15 | 2.6 | 68.1 |
| 6 | 1:49 | 3400 | 71.0 | 14 | 2.3 | 68.7 |
| 7 | 1:48 | 3350 | 71.7 | 27 | 4.4 | 67.3 |
| 8 | 1:53 | 3450 | 72.0 | 20 | 3.4 | 68.6 |
| 9 | 1:51 | 3450 | 70.3 | 18 | 3.2 | 67.1 |
| 10 | 1:54 | 3400 | 71.0 | 11 | 1.7 | 69.3 |
| | Average | 3410 | 70.99 | 17.30 | 2.90 | 68.09 |
| | Average | 13.81 | | | | |
| | Cups | | | | | |

TABLE 4
Formulation: Fat Free Butter-Test Bag
(Non-Fluorinated Bag Material with Metallized
Cellophane Susceptor with Optical Density of 0.192)
Bag: Full Size
Net Weight: 3.0 oz. (85.0 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 2:00 | 3350 | 70.9 | 27 | 4.6 | 66.3 |
| 2 | 1:55 | 3500 | 72.6 | 31 | 5.3 | 67.3 |
| 3 | 1:55 | 3550 | 72.6 | 26 | 4.4 | 68.2 |
| 4 | 1:55 | 3450 | 73.1 | 39 | 6.4 | 66.7 |
| 5 | 1:57 | 3400 | 70.3 | 19 | 3.0 | 67.3 |
| 6 | 1:55 | 3450 | 70.8 | 23 | 3.9 | 66.9 |
| 7 | 1:57 | 3400 | 73.4 | 34 | 5.7 | 67.7 |
| 8 | 1:57 | 3400 | 71.8 | 29 | 4.9 | 66.9 |
| 9 | 2:00 | 3400 | 71.9 | 24 | 4.0 | 67.9 |
| 10 | 2:00 | 3450 | 73.3 | 24 | 3.8 | 69.5 |
| | Average | 3435 | 72.07 | 27.60 | 4.60 | 67.47 |
| | Average | 13.91 | | | | |
| | Cups | | | | | |

TABLE 5
Formulation: Movie Theater Butter-Control Bag
(Fluorinated Bag Material with Metallized PET Susceptor)
Bag: Full Size
Net Weight: 3.2 oz. (90.7 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:38 | 2900 | 75.3 | 12 | 1.8 | 73.5 |
| 2 | 1:36 | 2800 | 76.5 | 17 | 2.7 | 73.8 |
| 3 | 1:37 | 2850 | 76.3 | 6 | 1.2 | 75.1 |
| 4 | 1:38 | 2950 | 77.7 | 7 | 1.1 | 76.6 |
| 5 | 1:35 | 2900 | 75.7 | 7 | 1.2 | 74.5 |
| 6 | 1:37 | 2850 | 76.9 | 13 | 2.3 | 74.6 |
| 7 | 1:39 | 2900 | 76.0 | 9 | 1.6 | 74.4 |
| 8 | 1:38 | 2800 | 77.0 | 20 | 3.3 | 73.7 |
| 9 | 1:38 | 2850 | 76.5 | 8 | 1.4 | 75.1 |
| 10 | 1:49 | 2950 | 77.2 | 3 | 0.5 | 76.7 |
| | Average | 2875 | 76.51 | 10.20 | 1.71 | 74.80 |
| | Average | 11.64 | | | | |
| | Cups | | | | | |

TABLE 6
Formulation: Movie Theater Butter-Control Susceptor
(Non-Fluorinated Bag Material with Metallized PET Susceptor)
Bag: Full Size
Net Weight: 3.2 oz. (90.7 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:37 | 2750 | 77.5 | 14 | 2.5 | 75.0 |
| 2 | 1:37 | 2750 | 76.2 | 14 | 2.3 | 73.9 |
| 3 | 1:38 | 2750 | 76.5 | 16 | 2.5 | 74.0 |
| 4 | 1:36 | 2750 | 77.1 | 18 | 3.4 | 73.7 |
| 5 | 1:38 | 2700 | 76.9 | 17 | 3.0 | 73.9 |
| 6 | 1:43 | 2750 | 76.5 | 13 | 2.4 | 74.1 |
| 7 | 1:47 | 2800 | 77.7 | 9 | 1.6 | 76.1 |
| 8 | 1:46 | 2850 | 77.0 | 13 | 2.2 | 74.8 |
| 9 | 1:35 | 2700 | 77.8 | 16 | 2.7 | 75.1 |
| 10 | 1:44 | 2800 | 77.8 | 6 | 1.1 | 76.7 |
| | Average | 2760 | 77.10 | 13.60 | 2.37 | 74.73 |
| | Average | 11.17 | | | | |
| | Cups | | | | | |

TABLE 7
Formulation: Movie Theater Butter-Test Bag
(Non-Fluorinated Bag Material with Metallized
Cellophane Susceptor with Optical Density of 0.175)
Bag: Full Size
Net Weight: 3.2 oz. (90.7 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:46 | 2600 | 75.8 | 7 | 1.2 | 74.6 |
| 2 | 1:47 | 2750 | 76.7 | 4 | 0.6 | 76.1 |
| 3 | 1:41 | 2750 | 75.6 | 4 | 0.7 | 74.9 |
| 4 | 1:42 | 2800 | 77.2 | 8 | 1.4 | 75.8 |
| 5 | 1:39 | 2850 | 77.2 | 3 | 0.6 | 76.6 |
| 6 | 1:37 | 2850 | 77.1 | 11 | 1.8 | 75.3 |
| 7 | 1:38 | 2700 | 76.0 | 14 | 2.5 | 73.5 |
| 8 | 1:37 | 2800 | 77.4 | 20 | 3.2 | 74.2 |
| 9 | 1:44 | 2800 | 75.7 | 4 | 0.6 | 75.1 |
| 10 | 1:37 | 2850 | 75.6 | 7 | 1.1 | 74.5 |
| | Average | 2775 | 76.43 | 8.20 | 1.37 | 75.06 |
| | Average | 11.23 | | | | |
| | Cups | | | | | |

TABLE 8
Formulation: Movie Theater Butter-Test Bag
(Non-Fluorinated Bag Material with Metallized
Cellophane Susceptor with Optical Density of 0.192)
Bag: Full Size
Net Weight: 3.2 oz. (90.7 g)
Bag Weight: 13 grams
Popped Product

| | | | Weight | | | |
|---|---|---|---|---|---|---|
| | Time in | Popped | of Bag | | | Weight |
| | Micro- | Bag | Contents | | Weight | of Edible |
| | wave | Volume | Popped | # of | of UPKs | Portion |
| Bag # | (min.) | (cc) | (g) | UPKs | (g) | (g) |
| 1 | 1:48 | 2850 | 72.5 | 15 | 2.6 | 69.9 |
| 2 | 1:45 | 2900 | 72.7 | 12 | 2.2 | 70.5 |
| 3 | 1:42 | 2850 | 70.2 | 17 | 2.9 | 67.3 |
| 4 | 1:45 | 2850 | 77.4 | 17 | 2.6 | 74.8 |
| 5 | 1:45 | 2800 | 74.6 | 17 | 2.7 | 71.9 |
| 6 | 1:46 | 2950 | 73.6 | 9 | 1.7 | 71.9 |
| 7 | 1:41 | 2900 | 72.9 | 23 | 4.0 | 68.9 |
| 8 | 1:46 | 2750 | 75.6 | 14 | 2.0 | 73.6 |
| 9 | 1:49 | 2850 | 74.3 | 10 | 1.5 | 72.8 |
| 10 | 1:43 | 2850 | 75.9 | 12 | 2.0 | 73.9 |
| | Average | 2855 | 73.97 | 14.60 | 2.42 | 71.55 |
| | Average | 11.56 | | | | |
| | Cups | | | | | |

### Example 2

A series of microwave popcorn test bags were prepared with non-fluorinated paper and susceptors with metallized cellophane or unmetallized cellophane. The bags were filled with popcorn and microwaved to evaluate pop volume. The performance of the test bags was compared to the performance of bags constructed of fluorinated paper and non-fluorinated bags and having a conventional metallized PET susceptor (optical density=approximately 0.26). Table 9 present the results of this evaluation. Surprisingly, the popcorn bags with a cellophane susceptor without any metallization provided for an average pop volume at least comparable to the popcorn bag constructed of non-fluorinated bag material with metallized PET susceptor.

TABLE 9

| | Average Test Bag Pop |
|---|---|
| Popcorn Bag Formulation | Volume 3 Bags (cc) |
| Fluorinated Bag Material with Metallized | 2,100 |
| PET Susceptor | |
| Non-Fluorinated Bag Material with | 1,540 |
| Metallized PET Susceptor | |
| Non-Fluorinated Bag Material with | 1,650 |
| Metallized Cellophane Susceptor (optical | |
| density = 0.18) | |
| Non-Fluorinated Bag Material with | 1,450 |
| Cellophane Susceptor (No metallization) | |

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above products and processes without departing from the scope of the invention, it is intended that all matter contained in the above description and shown in the accompanying drawings shall be interpreted as illustrative and not in a limiting sense.

What is claimed is:

1. A container comprising:
a perimeter wall that defines an interior of the container, the interior of the container being configured to receive a microwavable food item therein; and
a susceptor supported on the perimeter wall of the container, the susceptor comprising a substrate, wherein the substrate comprises a biodegradable polymer comprising a cellulosic polymer and optionally a coating supported on the substrate, and wherein the susceptor has an optical density that is no greater than about 0.2.

2. The container of claim 1 wherein the susceptor has an optical density that is no greater than about 0.18.

3. The container of claim 1 wherein the susceptor has an optical density that is no greater than about 0.15.

4. The container of claim 1 wherein the susceptor has an optical density that is no greater than about 0.12.

5. The container of claim 1 wherein the susceptor has an optical density that is no greater than about 0.1.

6. The container of claim 1 wherein the susceptor has an optical density that is no greater than about 0.05.

7. The container of any one of claims 1 to 6 wherein the coating supported on the substrate comprises a metal-containing material comprising at least one metal selected from the group consisting of titanium, aluminum, copper, nickel, zinc, gold, silver, tin, iron, and combinations thereof.

8. The container of any one of claims 1 to 7 wherein the coating supported on the substrate comprises at least one metal oxide selected from the group consisting of titania, alumina, and combinations thereof.

9. The container of any one of claims 1 to 8 wherein the coating supported on the substrate comprises a ceramic material.

10. The container of claim 1 wherein the cellulosic polymer comprises cellophane.

11. The container of claim 1 wherein the substrate is free or essentially free of a coating and/or metal.

12. The container of claim 1 or 11 wherein the substrate is free or essentially free of metals selected from the group consisting of titanium, aluminum, copper, nickel, zinc, gold, silver, tin, iron, and combinations thereof.

13. The container of any one of claim 1, 11, or 12 wherein the substrate is free or essentially free of metal oxides selected from the group consisting of Mania, alumina, and combinations thereof.

14. The container of any one of claims 1 or 11 to 13 wherein the substrate is free or essentially free of a ceramic material.

15. The container of any one of claims 1 or 11 to 14 wherein the susceptor consists or consists essentially of the biodegradable polymer.

16. The container of any one of claims 1 or 11 to 15 wherein the susceptor consists or consists essentially of the cellulosic polymer.

17. The container of any one of claims 1 or 11 to 16 wherein the susceptor consists or consists essentially of cellophane.

18. The container of any one of claims 1 or 11 to 17 wherein the container is free or essentially free of metals selected from the group consisting of titanium, aluminum, copper, nickel, zinc, gold, silver, tin, iron, and combinations thereof.

19. The container of any one of claims 1 or 11 to 18 wherein the container is free or essentially free of metal oxide selected from the group consisting of titania, alumina, and combinations thereof.

20. The container of any one of claims 1 or 11 to 19 wherein the container is free or essentially free of ceramic materials.

21. The container of any one of claims 1 to 9 wherein the coating on the substrate is patterned.

22. The container of any one of claims 1 to 9 wherein the patterned coating on the substrate is a non-random pattern.

23. The container of any one of claims 1 to 9 wherein the patterned coating on the substrate is a geometric pattern.

24. A container comprising:
a perimeter wall that defines an interior of the container, the interior of the container being configured to receive a microwavable food item therein; and
a susceptor supported on the perimeter wall of the container, the susceptor comprising a substrate and a coating supported on the substrate, wherein the substrate comprises a biodegradable polymer that has stable physical and/or chemical properties at temperatures of at least about 150° C.

25. The container of claim 24 wherein the biodegradable polymer comprises a cellulosic polymer.

26. The container of claim 24 or 25 wherein the biodegradable polymer comprises cellophane.

27. The container of any one of claims 24 to 26 wherein the biodegradable polymer comprises at least one polymer selected from the group consisting of polylactic acid (PLA), polyglycolic acid (PGA), poly(lactic-co-glycolic acid) (PLGA), polyhydroxyalkanoate (PHA), other natural polyesters, combinations of these polymers, and various blends containing these polymers.

28. The container of any one of claims 24 to 27 wherein the coating supported on the substrate comprises a metal-containing material comprising at least one metal selected from the group consisting of titanium, aluminum, copper, nickel, zinc, gold, silver, tin, iron, and combinations thereof.

29. The container of any one of claims 24 to 28 wherein the coating supported on the substrate comprises at least one metal oxide selected from the group consisting of titania, alumina, and combinations thereof.

30. The container of any one of claims 24 to 29 wherein the coating supported on the substrate comprises a ceramic material.

31. The container of any one of claims 24 to 30 wherein the susceptor has an optical density of from about 0.1 to about 0.5, from about 0.1 to about 0.4, from about 0.1 to about 0.3, from about 0.1 to about 0.2, from about 0.15 to about 0.5, from about 0.15 to about 0.4, from about 0.15 to about 0.35, from about 0.15 to about 0.3, from about 0.2 to about 0.5, from about 0.2 to about 0.4, from about 0.2 to about 0.3, from about 0.3 to about 0.5, from about 0.3 to about 0.4, or from about 0.4 to about 0.5.

32. The container of any one of claims 1 to 31 wherein the biodegradable polymer is a compostable polymer.

33. The container of any one of claims 1 to 32 wherein the biodegradable polymer has stable physical and/or chemical properties at temperatures of at least about 175° C. or at least about 200° C.

34. The container of any one of claims 1 to 33 wherein the container comprises a sheet of material forming the perimeter wall, first and second portions of the sheet comprise a biodegradable adhesive.

35. The container of any one of claims 1 to 34 wherein the container comprises a sheet of material forming the perimeter wall, first and second portions of the sheet being bonded together by a biodegradable heat seal adhesive.

36. The container of claim 34 or 35 wherein the adhesive is a compostable adhesive.

37. The container of any one of claims 1 to 36 wherein the container comprises a sheet of material forming the perimeter wall, the sheet of material comprising at least one paper layer of non-fluorinated paper.

38. The container of any one of claims 1 to 37 wherein the container comprises a sheet of material forming the perimeter wall, the sheet of material comprises an inner paper layer and an outer paper layer.

39. The container of claim 38 wherein the inner paper layer and the outer paper layer are non-fluorinated paper.

40. The container of claim 38 or 39 wherein the sheet of material further comprises an adhesive layer between the inner paper layer and the outer paper layer, the adhesive layer laminating the inner paper layer to the outer paper layer.

41. The container of any one of claims 28 to 40 wherein the susceptor is received between the inner paper layer and the outer paper layer.

42. The container of any one of claims 1 to 41 further comprising a microwavable food item received in the interior of the container.

43. The container of claim 42 wherein the microwavable food item comprises popcorn kernels.

44. A process for producing a microwavable container, the process comprising:
bonding a first layer of a first material and a susceptor with a first adhesive, wherein the susceptor comprises a substrate and a coating supported on the substrate and wherein the substrate comprises a biodegradable polymer that has stable physical and/or chemical properties at temperatures of at least about 150° C.;
bonding a second layer of a second material and the first layer with a second adhesive to form a laminate material wherein the susceptor is positioned between the first layer and the second layer; and
applying a third adhesive to one or more of a first end margin, a second end margin, and/or a longitudinal edge margin of the laminate material.

45. The process of claim 44 wherein the biodegradable polymer comprises a cellulosic polymer.

46. The process of claim 44 or 45 wherein the biodegradable polymer comprises cellophane.

47. The process of any one of claims 44 to 46 wherein the biodegradable polymer comprises at least one polymer selected from the group consisting of polylactic acid (PLA), polyglycolic acid (PGA), poly(lactic-co-glycolic acid) (PLGA), polyhydroxyalkanoate (PHA), other natural polyesters, combinations of these polymers, and various blends containing these polymers.

48. The process of any one of claims 44 to 47 wherein the biodegradable polymer is a compostable polymer.

49. The process of any one of claims 44 to 48 wherein the biodegradable polymer has stable physical and/or chemical properties at temperatures of at least about 175° C. or at least about 200° C.

50. The process of any one of claims 44 to 49 wherein the coating supported on the substrate comprises a metal-containing material comprising at least one metal selected from the group consisting of titanium, aluminum, copper, nickel, zinc, gold, silver, tin, iron, and combinations thereof.

51. The process of any one of claims 44 to 50 wherein the coating supported on the substrate comprises at least one metal oxide selected from the group consisting of titania, alumina, and combinations thereof.

52. The process of any one of claims 44 to 51 wherein the coating supported on the substrate comprises a ceramic material.

53. The process of any one of claims 44 to 52 wherein the susceptor has an optical density of from about 0.1 to about 0.5, from about 0.1 to about 0.4, from about 0.1 to about 0.3, from about 0.1 to about 0.2, from about 0.15 to about 0.5, from about 0.15 to about 0.4, from about 0.15 to about 0.35, from about 0.15 to about 0.3, from about 0.2 to about 0.5, from about 0.2 to about 0.4, from about 0.2 to about 0.3, from about 0.3 to about 0.5, from about 0.3 to about 0.4, or from about 0.4 to about 0.5.

54. The process of any one of claims 44 to 53 wherein the first adhesive, second adhesive, and third adhesive are each biodegradable and/or compostable adhesives.

55. The process of any one of claims 44 to 54 wherein the first material and second are non-fluorinated paper.

56. The process of any one of claims 44 to 55 further comprising sealing one or more of the first end margin, the second end margin, and/or the longitudinal edge margin of the laminate material.

57. The process of any one of claims 44 to 56 further comprising forming the microwavable container.

58. The process of any one of claims 44 to 57 further comprising filling the container with a microwavable food item.

59. The process of claim 58 wherein the microwavable food item comprises popcorn kernels.

60. The process of any one of claims 44 to 59 wherein the process is for producing a container of any one of claims 1 to 43.
